(19) United States
(12) Patent Application Publication
(10) Pub. No.: US 2020/0202707 A1
(43) Pub. Date: Jun. 25, 2020

(54) MULTI-PATH ROUTING OF NETWORKED AUTOMATED VEHICLES

(71) Applicant: DISH Network L.L.C., Englewood, CO (US)

(72) Inventor: Jeff McSchooler, Englewood, CO (US)

(21) Appl. No.: 16/228,693

(22) Filed: Dec. 20, 2018

(51) Int. Cl. G08G 1/01; G01C 21/34; G05D 1/00; G05D 1/02; H04W 4/40

(52) U.S. Cl. CPC G08G 1/0145; G01C 21/3415; G01C 21/3492; G08G 1/0112; H04W 84/18; G05D 1/0287; G05D 1/0276; H04W 4/40; G05D 2201/0213; G05D 1/0088

(57) ABSTRACT

Novel techniques are described for multi-path routing of networked automated vehicles, including seeking concurrent rerouting solutions for multiple automated vehicles via multiple alternate routing paths in a manner that accounts for and addresses aggregate impacts across the multiple automated vehicles over a window of time. For example, in response to detecting a traffic event, an impacted vehicle set can be determined as a group of automated vehicles to be impacted by the traffic event. Multiple alternative routing options can be computed as available for physical routing of the impacted vehicle set; and a multi-path rerouting of the impacted vehicle set can be computed by assigning each automated vehicle to one of multiple subsets, and assigning each subset to one of the alternative routing options. Each automated vehicle can be directed to travel in accordance with the respective alternative routing option assigned to its subset.

### FIELD

This invention relates generally to automated vehicles, and, more particularly, to multi-path routing of networked automated vehicles.

### BACKGROUND

As vehicles traverse roadways, they may encounter various types of traffic conditions, such as traffic accidents, roadway damage, roadway obstructions, pedestrians in the roadway, slow-downs, and the like. Historically, a human driver encountering such a traffic condition may notice the condition itself, or may notice a resulting impact on traffic flow (e.g., excessively slow-moving traffic ahead); and the human driver may or may not have an opportunity to avoid being impacted by the condition. For example, alternate routes may or may not be available to the human driver, and/or the human driver may or may not know whether those alternate route will yield an improved driving experience.

More recently, human drivers have benefitted from the aid of mapping applications (e.g., using global positioning satellite (GPS) devices) to become aware of impending traffic conditions and/or to find and analyze potential alternate routes. Such applications can tend to seek a best route for a particular vehicle at a particular time. For example, after an accident occurs on a main road, and traffic begins slows on that road, such a mapping application may determine that it has become faster for to use a particular side road; and the application may indicate such to the driver using the application. As each subsequent driver receives such an indication, more drivers may begin to use the side road, and traffic may slow there, as well. Accordingly, in many instances, such applications tend to be limited by seeking optimizations that account for conditions of a particular applications user at a particular time. Conventional approaches tend to lack any practical way to account for, or to address, aggregate impacts across multiple vehicles over a window of time, and therefore tend to yield sub-optimal results.

### BRIEF SUMMARY

Among other things, embodiments provide novel systems and methods for multi-path routing of networked automated vehicles, including seeking concurrent rerouting solutions for multiple automated vehicles via multiple alternate routing paths in a manner that accounts for and addresses aggregate impacts across the multiple automated vehicles over a window of time. For example, in response to detecting a traffic event, an impacted vehicle set can be determined as a group of automated vehicles to be impacted by the traffic event. Multiple alternative routing options can be computed as available for physical routing of the impacted vehicle set; and a multi-path rerouting of the impacted vehicle set can be computed by assigning each automated vehicle to one of multiple subsets, and assigning each subset to one of the alternative routing options. Each automated vehicle can be directed to travel in accordance with the respective alternative routing option assigned to its subset.

According to one set of embodiments, a method is provided for multi-path routing of networked automated vehicles. The method includes: receiving a traffic event trigger responsive to detection, by a sensor of a detecting automated vehicle of a plurality of automated vehicles, of a traffic event proximate to the detecting automated vehicle, the plurality of automated vehicles being in communication with each other via a communication network; determining, responsive to the traffic event trigger, an impacted vehicle set as those of the plurality of automated vehicles to be impacted by the traffic event; computing, responsive to the traffic event trigger, a plurality of alternative routing options available for physical routing of the impacted vehicle set; computing a multi-path rerouting of the impacted vehicle set by assigning each of the automated vehicles of the impacted vehicle set to one of a plurality of subsets, and assigning each of the plurality of subsets to a respective one of the plurality of alternative routing options, such that the multi-path rerouting of the impacted vehicle set mitigates an aggregated impact of the traffic event on the impacted vehicle set; and directing each of the automated vehicles of the impacted vehicle set, via the communication network, to travel in accordance with the respective one of the plurality of alternative routing options assigned to its subset.

According to another set of embodiments, a multi-path routing system is provided for networked automated vehicles. The system includes an event detector, a vehicle tracker, a multi-path routing processor, and an automated vehicle controller. The event detector is to generate a traffic event trigger responsive to detection, by a sensor of a detecting automated vehicle of a plurality of automated vehicles, of a traffic event proximate to the detecting automated vehicle, the plurality of automated vehicles being in communication with each other via a communication network. The vehicle tracker is in communication with the event detector to determine, responsive to the traffic event trigger, an impacted vehicle set as those of the plurality of automated vehicles to be impacted by the traffic event. The multi-path routing processor is in communication with the event detector and the vehicle tracker to: compute a plurality of alternative routing options available for physical routing of the impacted vehicle set responsive to the traffic event trigger and in accordance with stored mapping data; and compute a multi-path rerouting of the impacted vehicle set by assigning each of the automated vehicles of the impacted vehicle set to one of a plurality of subsets, and assigning each of the plurality of subsets to a respective one of the plurality of alternative routing options, such that the multi-path rerouting of the impacted vehicle set mitigates an aggregated impact of the traffic event on the impacted vehicle set. The automated vehicle controller is in communication with the multi-path routing processor and the communication network to direct each of the automated vehicles of the impacted vehicle set, via the communication network, to travel in accordance with the respective one of the plurality of alternative routing options assigned to its subset.

According to another set of embodiments, a system is provided for multi-path routing of networked automated vehicles. The system includes a network interface coupled with a communication network, one or more processors, and non-transient memory. The memory has, stored thereon, instructions, which, when executed, cause the one or more processors to perform steps comprising: receiving a traffic event trigger responsive to detection, by a sensor of a detecting automated vehicle of a plurality of automated vehicles, of a traffic event proximate to the detecting automated vehicle, the plurality of automated vehicles being in communication with each other via a communication network; determining, responsive to the traffic event trigger, an impacted vehicle set as those of the plurality of automated vehicles to be impacted by the traffic event; computing, responsive to the traffic event trigger, a plurality of alternative routing options available for physical routing of the impacted vehicle set; and computing a multi-path rerouting of the impacted vehicle set by assigning each of the automated vehicles of the impacted vehicle set to one of a plurality of subsets, and assigning each of the plurality of subsets to a respective one of the plurality of alternative routing options, such that the multi-path rerouting of the impacted vehicle set mitigates an aggregated impact of the traffic event on the impacted vehicle set.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The present disclosure is described in conjunction with the appended figures:

FIG. 1 shows a network environment as a context for various embodiments;

FIG. 2 shows an example of a roadway environment having a number of automated vehicles in context of a traffic event;

FIGS. 3A-3C show multiple network environments having illustrative multi-path routing systems with components implemented in different ways, according to various embodiments;

FIG. 4 provides a schematic illustration of one embodiment of a computer system that can implement various system components and/or perform various steps of methods provided by various embodiments; and

FIG. 5 shows a flow diagram of an illustrative method for multi-path routing of networked automated vehicles, according to various embodiments.

In the appended figures, similar components and/or features may have the same reference label. Further, various components of the same type may be distinguished by following the reference label by a second label (e.g., a lower-case letter) that distinguishes among the similar components. If only the first reference label is used in the specification, the description is applicable to any one of the similar components having the same first reference label irrespective of the second reference label.

### DETAILED DESCRIPTION

Embodiments of the disclosed technology will become clearer when reviewed in connection with the description of the figures herein below. In the following description, numerous specific details are set forth to provide a thorough understanding of the present invention. However, one having ordinary skill in the art should recognize that the invention may be practiced without these specific details. In some instances, circuits, structures, and techniques have not been shown in detail to avoid obscuring the present invention.

As vehicles traverse roadways, they may encounter various types of traffic events. In context of non-automated vehicles, human drivers tend to have limited information, and often limited motivation, when choosing how to respond to an impending traffic event. Historically, a human driver may notice the traffic event, or a resulting impact on traffic flow (e.g., excessively slow-moving traffic ahead). In response, the human driver may stay on the current course (e.g., by choice, or because no alternatives are available), may look for an alternate route (e.g., by turning at the next intersection), etc. More recently, human drivers have benefitted from the aid of mapping applications (e.g., using global positioning satellite (GPS) devices) to become aware of impending traffic conditions and/or to find and analyze potential alternate routes. Such applications tend to seek a best route for a particular driver (the driver using the application) at a particular time. However, the limited purview of such conventional applications tends to yield sub-optimal results in the aggregate, as they tend not to include any practical or effective way to account for, or to address, aggregate impacts across multiple vehicles over a window of time.

Embodiments described herein operate in context of networked automated vehicles, including partially and fully autonomous vehicles, to seek concurrent rerouting solutions for multiple vehicles via multiple alternate routing paths, referred to interchangeably herein as “multi-path routing,” or “multi-path rerouting.” Such multi-path routing can account for and address aggregate impacts across the multiple automated vehicles over a window of time. For example, in response to detecting a traffic event, an impacted vehicle set can be determined as a group of automated vehicles to be impacted by the traffic event. Multiple alternative routing options can be computed as available for physical routing of the impacted vehicle set; and a multi-path rerouting of the impacted vehicle set can be computed by assigning each automated vehicle to one of multiple subsets, and assigning each subset to one of the alternative routing options. Each automated vehicle can be directed to travel in accordance with the respective alternative routing option assigned to its subset.

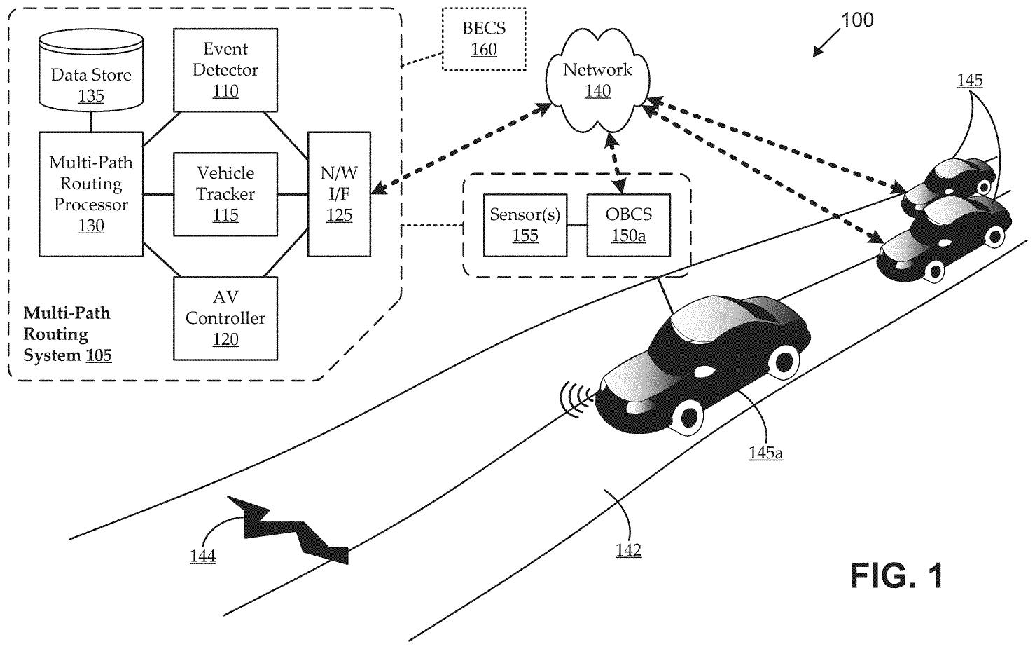

Turning to FIG. 1, a network environment 100 is shown as a context for various embodiments. The network environment 100 includes multiple automated vehicles 145 traveling on a roadway 142. The automated vehicles 145 can include any partially or fully autonomous vehicles that travel along with other vehicles (e.g., automated and/or non-automated) and that may encounter traffic events 144. For example, automated vehicles 145 can include automated cars, buses, trucks, trams, utility vehicles, maintenance vehicles, construction vehicles, public transit vehicles, etc. In general, automated vehicles 142 include various sensors and automated controls (including automated driving controls) by which a computational system can direct the travel (e.g., direction, speed, path, etc.) of the vehicle fully or partly without human intervention. As used herein, traffic events 144 generally refer to any type of condition that can have an impact on the flow of traffic along in a particular location. Examples of traffic events 144 include traffic accidents, roadway 142 damage (e.g., pot holes or sink holes), roadway 142 obstructions (e.g., objects, animals, or pedestrians in the roadway 142), roadway 142 condition (e.g., ice), slow-downs, localized weather events (e.g., severe thunderstorms, tornadoes, hail, etc.), and the like.

At any particular time, some or all of the automated vehicles 145 are in wireless communication with each other via one or more communication networks 140. The communication network(s) 140 can include any other suitable type of network by which wireless communication links can be established directly or indirectly between the automated vehicles 145. In some embodiments, some or all automated vehicles 145 include antennas and transceivers by which to communicate with nearby cellular towers, with one or more satellites, with one or more nearby relay stations, and/or with any other infrastructure that can send and receive wireless communications. The infrastructure can be in further communication with one or more other networks, such as with the Internet and/or any other public and/or private networks, cellular networks, satellite networks, cable networks, fiber-optic networks, backhaul networks, etc.

In other embodiments, the communication network(s) 140 can include wireless ad hoc networks. The one or more wireless ad hoc networks can be implemented in any suitable manner that enables a dynamically changing set of nodes (i.e., including at least some of the automated vehicles 145) to self-configure wireless communications with each other, as needed. For example, as automated vehicles 145 change position relative to each other, each can autonomously determine which wireless links to form, shed, heal, etc. with other automated vehicles 145; which network traffic to route, in which ways to route the traffic, and which protocols to use for routing (e.g., each automated vehicle 145 potentially acting as a router in various communication transactions); etc. In some such embodiments, the ad hoc network(s) can dynamically form as peer-to-peer networks based on proximity. For example, a particular automated vehicle 145 can dynamically and automatically negotiate wireless connectivity with all compatible automated vehicles 145 within a particular geographic region.

Each of the automated vehicles 145 includes an on-board computational system (OBCS) 150 and one or more sensors 155 in communication with the OBCS 150. The OBCS 150 can include one or more processor devices and one or more memory devices, such as non-transient processor-readable memory devices. In some embodiments, each OBCS 150 includes a network interface (e.g., including any suitable antennas, transceivers, etc.) by which the automated vehicle 145 having the OBCS 150 can communicate with the communication network(s) 140. The sensors 155 can include any suitable sensors for detecting traffic events 144, such as cameras, proximity sensors (e.g., using radar, laser, and/or any other suitable components), accelerometers, location sensors, temperature sensors, humidity sensors, etc. In some embodiments, all the automated vehicles 145 have similar capability with respect to detecting traffic events 144. In other embodiments, certain of the automated vehicles 145 are less capable, or incapable, of detecting some or all types of traffic events 144.

As illustrated, the environment 100 includes a multi-path routing system 105. In some implementations, the multi-path routing system 105 is implemented by the OBCS 150. For example, each of some or all of the automated vehicles 145 can have a respective instance of the multi-path routing system 105 implemented by its local OBCS 150. In other implementations, the multi-path routing system 105 is accessible to one or more OBCSs 150 of one or more automated vehicles 145 via the communication network(s) 140. In such implementations, the multi-path routing system 105 can be implemented by one or more back-end computational systems 160. The back-end computational system(s) 160 can be implemented as one or more server computer, or the like, that is in accessible via the communication network(s) 140 and may or may not be distributed across multiple locations and/or physical computational devices. For example, the back-end computational system(s) 160 can be a cloud-based server having suitable processing and storage capacity (e.g., fixed or dynamic) for executing suitable applications, as described herein.

Embodiments of the multi-path routing system 105 can include some or all of an event detector 110, a vehicle tracker 115, an automated vehicle controller 120, a network interface 125, a multi-path routing processor 130, and a data store 135. The event detector 110 can generate a traffic event trigger responsive to detection, by the sensor(s) 155 sensor of a detecting automated vehicle 145, of a traffic event 144 proximate to the detecting automated vehicle 145. For example, the network environment 100 shows an illustrative obstruction in the roadway 142, such as an ice patch or oil spill on the roadway 142, a large fissure in the roadway 142 surface, debris in the roadway 142, etc., which may be detected by a camera, proximity sensor, and/or other sensor 155 of the approaching automated vehicle 145a.

In response to the detection by the sensor(s) 155, the event detector 110 can generate a traffic event trigger. In some implementations, the traffic event trigger is generated to include information characterizing event parameters of the detected traffic event 144 and/or characterizing response parameters to inform one or more possible response options. For example, the traffic event trigger can indicate a location of the detected traffic event 144, a size of impact caused by the detected traffic event 144 (e.g., number of lanes impacted by the detected traffic event), a category of detected traffic event 144 (e.g., whether the detected traffic event 144 corresponds to a slick road condition, a complete obstruction of the roadway, etc.), a category of related response (e.g., a condition addressable by changing speed, a condition addressable by changing lanes, a condition requiring a complete stoppage of traffic, a condition requiring rerouting to one or more different roadways 142, etc. In some embodiments, the event detector 110 generates the traffic event trigger responsive to receiving multiple trigger signals, each responsive to detection, by one or more sensors of a respective one of multiple detecting automated vehicles 145, and responsive to determining that the multiple trigger signals collectively indicate the traffic event. The trigger signals from the multiple automated vehicles 145 can be aggregated and collectively analyzed to provide various features, such as verifying the detected traffic event 144 (e.g., certain types of traffic events 144 may trigger a multi-path routing response only when verified as detected by multiple vehicles), computing parameters of the traffic event 144 (e.g., the location and/or size of the traffic event 144 may be computed by using imagery collected from different vehicles at different positions and angles), secondary impacts of the traffic event 144 (e.g., a hazardous chemical spill may be detected visually by a camera of a nearby automated vehicle 145, and a chemical signature of the spill may be detected by an air quality sensor of an automated vehicle 145 that is farther away), etc.

Embodiments of the vehicle tracker 115 can be in communication with the event detector 110 to determine, responsive to the traffic event trigger, an impacted vehicle set. The impacted vehicle set can be determined as those of the automated vehicles 145 predicted to be impacted by the traffic event. In some embodiments, as described above, the communication network(s) 140 include an ad hoc network (e.g., a mobile vehicle ad hoc network) having member nodes that dynamically change in accordance with which of the automated vehicles 145 is in proximity to at least one other of the automated vehicles 145 that presently corresponds to a member node of the ad hoc network. In such an embodiment, some or all of the automated vehicles 145 of the impacted vehicle set can be in communication via the ad hoc network. In some such embodiment, the impacted vehicle set is determined according to which of the automated vehicles 145 is part of a same ad hoc network as the detecting automated vehicle 145, shown as automated vehicle 145a in FIG. 1 (e.g., all automated vehicles 145 presently in the ad hoc network are considered part of the impacted vehicle set, or all automated vehicles 145 part of the ad hoc network and within a particular geographic region with respect to the detecting automated vehicle 145a are part of the impacted vehicle set). For example, the detecting automated vehicle 145a can be in ad hoc communication with a set of proximate automated vehicles 145, those can be in ad hoc communication with a further set of automated vehicles 145, and so on; and the impacted vehicle set can be comprised of the set of nodes within some maximum number of hops from the detecting automated vehicle 145a, within some physical proximity of the detecting automated vehicle 145a, etc.

Embodiments of the multi-path routing processor 130 can be in communication with the event detector 110 and the vehicle tracker 110. The multi-path routing processor 130 can compute multiple alternative routing options available for physical routing of the impacted vehicle set responsive to the traffic event trigger. Each alternative routing option can include any suitable one or more changes to the physical routing of one or more automated vehicles 145 with respect to one or more roadways 142. Some alternative routing options can include one or more changes in speed, such as indicating for one or more vehicles to speed up or slow down by a certain amount, and/or for one or more vehicles to stop moving. Other alternative routing options can include one or more changes in lane, such as moving over to the left or right by one or more lanes. For example, such alternative routing options can account for the location and size of the detected traffic event 144, parameters of the roadway 142 (e.g., number of lanes, existence of shoulders or emergency lanes, locations of on-ramps or off-ramps, locations of intersections, etc.), locations of other vehicles on the roadway 142 (e.g., which can limit when and how vehicles can change lanes), etc. Other alternative routing options can include one or more changes in roadway 142, such as indicating for one or more vehicles to exit the present roadway 142 at one or more off-ramps, intersections, etc. Some alternative routing options can include constraints as to categories or groupings of vehicles that may be particularly well suited, or particularly excluded, from one or more options. For example, certain automated vehicles 145 may not be permitted to use certain roadways 142 due to height or weight restrictions, or the like; or options may be limited for a certain automated vehicle 145 due to the vehicles' turning radius, maximum speed, minimum braking distance, etc.

In some embodiments, the data store 135 has mapping data stored thereon. The mapping data can include any suitable geospatial information and/or any suitable road map information. For example, the mapping data can include maps of local roadways 142 and parameters of those roadways 142, such as respective speed limits, surface types (e.g., dirt, asphalt, etc.), number of lanes, existence of shoulders, distances, etc. In such embodiments, the multi-path routing processor 130 can compute the multiple alternative routing options in accordance with the mapping data stored at the data store 135. In some implementations, the mapping data is stored and provided by a remote mapping service accessible via the communication network(s) 140. For example, the mapping data can be accessible via a an application programming interface to a public or subscription mapping application, or the like.

Having computed the multiple alternative routing options, embodiments of the multi-path routing processor 130 can also compute a multi-path rerouting of the impacted vehicle set by assigning the automated vehicles 145 to the various alternative routing options. In some embodiments, the multi-path routing processor 130 assigns each of the automated vehicles 145 to one of multiple of subsets (e.g., so that each subset has one or more automated vehicles 145), and assigns each subset to a respective one of the alternative routing options. The assignment is such that multiple of the alternative routing options are exploited concurrently by different groups of the automated vehicles 145, and such that the multi-path rerouting of the impacted vehicle set mitigates an aggregated impact of the traffic event 144 on the impacted vehicle set.

Embodiments of the automated vehicle controller 120 can be in communication with the multi-path routing processor 130 and the communication network(s) 140, to direct each of the automated vehicles automated vehicles 145 of the impacted vehicle set, via the communication network(s) 140, to travel in accordance with the respective one of the alternative routing options assigned to its subset. For example, a first subset of automated vehicles 145, traveling on a first roadway 142 on which the traffic event 144 is detected, is assigned to an alternative routing option indicating to slow down; a second subset of automated vehicles 145 traveling on the first roadway 142 is assigned to an alternative routing option indicating to exit onto a second roadway at a next off-ramp; and a third subset of automated vehicles 145 already traveling on the second roadway 142 is assigned to an alternative routing option indicating to adjust their speed and spacing to facilitate safe entry of the second subset. In such an example, the automated vehicle controller 120 can direct each subset of automated vehicles 145 to act in accordance with its assigned alternative routing option. For example, the OBCS 150 of a particular one of the automated vehicles 145 can receive instructions over the communication network(s) 140 in accordance with its assigned alternative routing option, and the OBCS 150 can communicate with automated and/or assisted vehicle control systems (e.g., steering system, braking system, acceleration system, etc.) to carry out the received instructions.

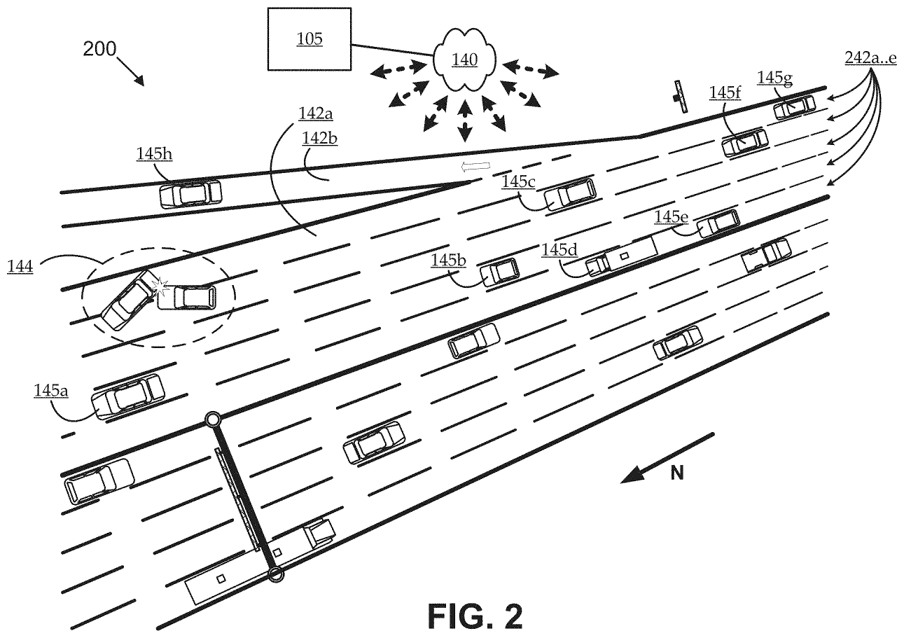

For the sake of illustration, FIG. 2 shows an example of a roadway environment 200 having a number of automated vehicles 145 in context of a traffic event 144. In the illustrated environment 200, most of the automated vehicles 145 are traveling on a primary roadway 142a, which is a highway having five lanes 242 in each direction and no shoulders. There is also a secondary roadway 142b associated with an off-ramp from the primary roadway 142a. Some or all of the automated vehicles 145 in the environment 200 are in communication via communication network(s) 140, such as via an ad hoc network. Some or all of the automated vehicles 145 are also in communication with one or more multi-path routing system 105. For example, the multi-path routing system 105 may be implemented in an OBCS 150 of a particular one of the automated vehicles 145, in a back-end computational system 160, or in any other suitable manner.

As illustrated, a vehicle collision has occurred (shown as traffic event 144), and the vehicles involved in the collision are blocking the two rightmost northbound lanes of the primary roadway 142a. Different ones of the illustrated vehicles in the environment 200 may or may not be impacted by the traffic event 144, and those impacted vehicles may have different options for responding to the traffic event 144. The traffic event 144 can be detected by one or more sensors of automated vehicle 145b (e.g., and, possibly, one or more sensors of one or more other automated vehicles 145). In response, the event detector 110 can generate a traffic event trigger. The vehicle tracker 115 can then determine an impacted vehicle set. For example, the vehicle tracker 115 can determine travel parameters (e.g., present locations, and directions of travel, speed, etc.) of all nearby automated vehicles 145, and can determine a relationship between those travel parameters and the detected traffic event 144. In the illustrated environment 200, automated vehicles 145b-145g may be determined as part of the impacted vehicle set, while others of the vehicles may not. For example, automated vehicle 145a has already past the traffic event 144, automated vehicle 145h has already exited onto the secondary roadway 142b, and all other vehicles in the environment are traveling in a southbound direction and will not be directly impacted by the blocked lanes. In some implementations, the vehicle tracker 115 can determine that other vehicles are not part of the impacted vehicle set, such as automated vehicles 145b, 145d, and 145e, which are already in unobstructed lanes 242.

Having determined the impacted vehicle set, the multi-path routing processor 130 can compute alternative routing options available for physical routing of the impacted vehicle set responsive to the traffic event trigger. For example, the computed alternative routing options in the illustrated case can include changing speed, changing lanes 242, exiting onto the secondary roadway 142b, etc. The multi-path routing processor 130 can then compute a multi-path rerouting of the impacted vehicle set by assigning each of the automated vehicles of the impacted vehicle set to one of the alternative routing options (e.g., by assigning subsets of vehicles to alternative routing options). For example, automated vehicle 145c can be assigned to an alternative routing option indicating a change of lanes 242 to the left; automated vehicle 145f can be assigned to an alternative routing option indicating exiting onto the secondary roadway 142b at the off-ramp, including an immediate change of lanes to the right; and automated vehicle 145g can be assigned to an alternative routing option indicating exiting onto the secondary roadway 142b at the off-ramp, including a reduction of speed to permit safe lane changing by automated vehicle 145f. The automated vehicle controller 120 can direct each of those automated vehicles 145, via the communication network(s) 140, to travel in accordance with their respective assigned alternative routing options. For example, instructions received by each of the impacted automated vehicles 145 can cause vehicle control systems to adjust steering, speed, etc. in accordance with carrying out its assigned alternative routing option.

Turning back to FIG. 1, in some embodiments, carrying out of a particular alternative routing option can involve additional features. In some implementations, information about the detected traffic event 144 and/or about the assigned alternative routing option can be displayed to a passenger of an affected automated vehicle 145 (e.g., via an in-vehicle display coupled with the OBCS 150, via a smart phone or other mobile device of the passenger, or in any other suitable manner). In other implementations, additional audible and/or visual indications can be actuated in accordance with carrying out the particular alternative routing option. For example, brake lights, turn signals, headlights, taillights, horns, and/or other indicators can be actuated to signal or warn nearby, non-automated vehicles about the detected traffic event 144 and/or about the assigned alternative routing option. In other implementations, some or all of the automated vehicles 145 can be provided with one or more of the alternative routing options as options selectable by a passenger of an affected automated vehicle 145. For example, an in-vehicle display can indicate: “Traffic accident detected ahead. Re-routing to an alternative roadway. Press ‘cancel’ in the next 10 seconds to remain on the current roadway.” In such implementations, when a vehicle opts out of a suggested alternative routing option, embodiments can automatically present another suggested alternative routing option, can re-compute alternative routing options for that vehicle and/or other (e.g., all) vehicles of the impacted vehicle set, and/or respond in any other suitable manner.

In some embodiments, the multi-path routing processor 130, automated vehicle controller 120, and/or other components of the multi-path routing system 105 can operate iteratively to generate multiple staged of multi-path rerouting. According to certain such embodiments, subsequent to computing the multi-path rerouting of the impacted vehicle set, the multi-path routing processor 130 can compute a further-impacted vehicle set as those of the automated vehicles 145 to be impacted by the multi-path rerouting of the impacted vehicle set. For example, the further-impacted vehicle set can be disjoint from the impacted vehicle set. The multi-path routing processor 130 can then compute a respective updated routing path for physical routing of each of the automated vehicles of the further-impacted vehicle set (e.g., in the manner described above for computing the alternative routing options for the impacted vehicle set), and the automated vehicle controller 120 can direct each automated vehicle 145 of the further-impacted vehicle set to travel in accordance with its respective updated routing path.

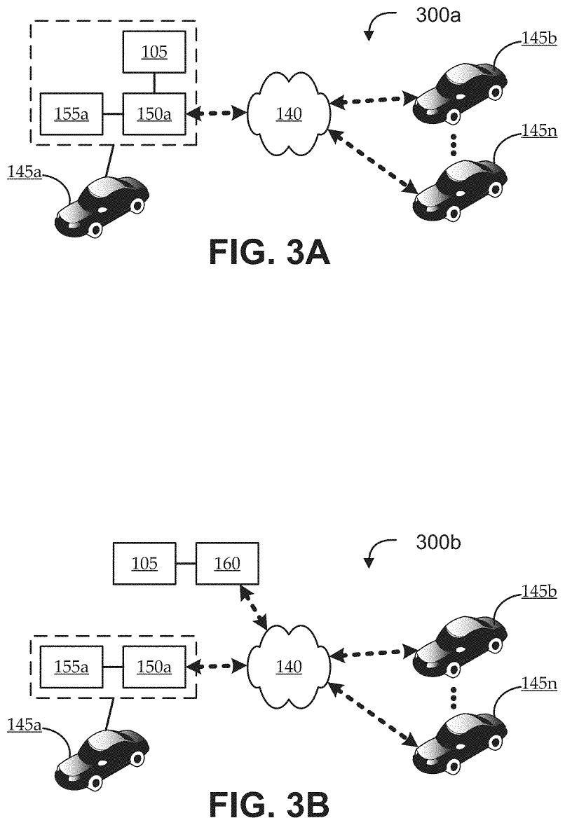

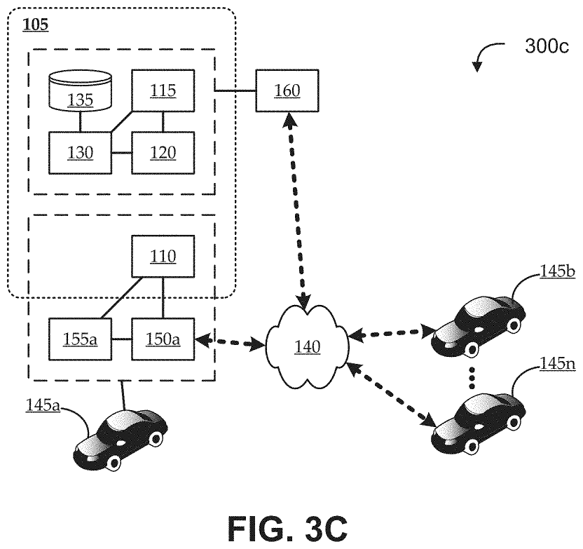

Various features of the multi-path routing system 105 can be implemented in various ways, including by locating and/or distributing components of the multi-path routing system 105 in different ways. FIGS. 3A-3C show multiple network environments 300 having illustrative multi-path routing systems 105 with components implemented in different ways, according to various embodiments. Turning first to FIG. 3A, an environment 300a is shown in which the multi-path routing system 105 is implemented at one or more automated vehicles 145. In one such embodiment, a particular one of the automated vehicles 145, automated vehicle 145a, includes an in-vehicle system having (or in communication with) one or more sensors 155, an OBCS 150, and the multi-path routing system 105. In another such embodiment, multiple (e.g., all) of the automated vehicles 145 have in-vehicle systems with their own sensors 155 and OBCS 150, and each implements a respective instance of the multi-path routing system 105. In such embodiments, a particular automated vehicle 145 can detect a traffic event 144 using its sensor(s) 155. In response thereto, its local event detector 110 can generate a traffic event trigger, its local vehicle tracker 115 can determine the impacted vehicle set, its local multi-path routing processor 130 can compute alternative routing options and assigning those options to the impacted vehicle set, and its local automated vehicle controller 120 can direct other automated vehicles 145 of the impacted vehicle set (over the communication network(s) 140) to travel in accordance with their assigned alternative routing options.

In FIG. 3B, an environment 300b is shown in which the multi-path routing system 105 is implemented by one or more back-end computational system(s) 160. For example, one or more automated vehicles 145 includes an in-vehicle system having (or in communication with) one or more sensors 155 and an OBCS 150. When a particular automated vehicle 145 detects a traffic event 144 using its sensor(s) 155, one or more signals are communicated, via the communication network(s) 140, to the back-end computational system(s) 160. At the back-end computational system(s) 160, the event detector 110 can generate a traffic event trigger, the vehicle tracker 115 can determine the impacted vehicle set, the multi-path routing processor 130 can compute alternative routing options and assign those options to the impacted vehicle set, and the automated vehicle controller 120 can direct other automated vehicles 145 of the impacted vehicle set (over the communication network(s) 140) to travel in accordance with their assigned alternative routing options.

In FIG. 3C, an environment 300c is shown in which components of the multi-path routing system 105 are distributed across multiple locations. As shown, each of one or more automated vehicles 145 includes an in-vehicle system having (or in communication with) one or more sensors 155 and an OBCS 150, and each also includes an instance of the event detector 110 of the multi-path routing system 105. Other components of the multi-path routing system 105 are implemented by one or more back-end computational system(s) 160 in communication with the one or more automated vehicles 145 via one or more communication network(s) 140. When a particular automated vehicle 145 detects a traffic event 144 using its sensor(s) 155, its local event detector 110 can generate a traffic event trigger. The traffic event trigger can be communicated (e.g., by the vehicle's OBCS 150) via the communication network(s) 140 to the back-end computational system(s) 160. At the back-end computational system(s) 160, the vehicle tracker 115 can determine the impacted vehicle set, the multi-path routing processor 130 can compute alternative routing options and assign those options to the impacted vehicle set, and the automated vehicle controller 120 can direct other automated vehicles 145 of the impacted vehicle set (over the communication network(s) 140) to travel in accordance with their assigned alternative routing options.

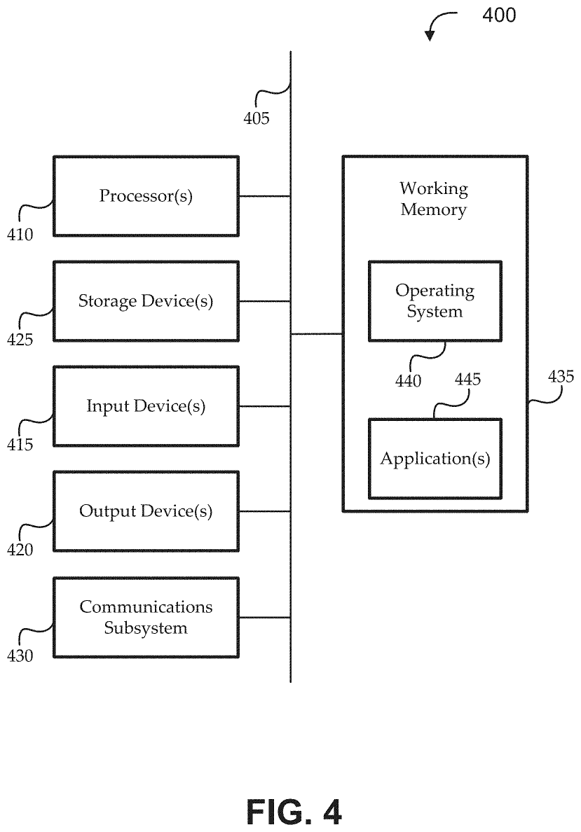

Embodiments of the multi-path routing system 105, or components thereof, can be implemented on, and/or can incorporate, one or more computer systems, as illustrated in FIG. 4. FIG. 4 provides a schematic illustration of one embodiment of a computer system 400 that can implement various system components and/or perform various steps of methods provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown including hardware elements that can be electrically coupled via a bus 405 (or may otherwise be in communication, as appropriate). The hardware elements may include one or more processors 410, including, without limitation, one or more general-purpose processors and/or one or more special-purpose processors (such as digital signal processing chips, graphics acceleration processors, video decoders, and/or the like); one or more input devices 415, which can include, without limitation, a mouse, a keyboard, remote control, and/or the like; and one or more output devices 420, which can include, without limitation, a display device, a printer, and/or the like.

The computer system 400 may further include (and/or be in communication with) one or more non-transitory storage devices 425, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including, without limitation, various file systems, database structures, and/or the like.

The computer system 400 can also include a communications subsystem 430, which can include, without limitation, a modem, a network card (wireless or wired), an infrared communication device, a wireless communication device, and/or a chipset (such as a Bluetooth™ device, an 402.11 device, a WiFi device, a WiMax device, cellular communication device, etc.), and/or the like. The communications subsystem 430 may permit data to be exchanged with a network (such as the various networks described herein), other computer systems, and/or any other devices described herein. In many embodiments, the computer system 400 will further include a working memory 435, which can include a RAM or ROM device, as described herein.

The computer system 400 also can include software elements, shown as currently being located within the working memory 435, including an operating system 440, device drivers, executable libraries, and/or other code, such as one or more application programs 445, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or codes can be stored on a non-transitory computer-readable storage medium, such as the non-transitory storage device(s) 425 described above. In some cases, the storage medium can be incorporated within a computer system, such as computer system 400. In other embodiments, the storage medium can be separate from a computer system (e.g., a removable medium, such as a compact disc), and/or provided in an installation package, such that the storage medium can be used to program, configure, and/or adapt a general purpose computer with the instructions/code stored thereon. These instructions can take the form of executable code, which is executable by the computer system 400 and/or can take the form of source and/or installable code, which, upon compilation and/or installation on the computer system 400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computer system 400) to perform methods in accordance with various embodiments of the invention. According to a set of embodiments, some or all of the procedures of such methods are performed by the computer system 400 in response to processor 410 executing one or more sequences of one or more instructions (which can be incorporated into the operating system 440 and/or other code, such as an application program 445) contained in the working memory 435. Such instructions may be read into the working memory 435 from another computer-readable medium, such as one or more of the non-transitory storage device(s) 425. Merely by way of example, execution of the sequences of instructions contained in the working memory 435 can cause the processor(s) 410 to perform one or more procedures of the methods described herein.

In some embodiments, the computer system 400 implements a system for multi-path routing of networked automated vehicles, as described herein, in accordance with instructions stored in working memory 435 and executable by the processor(s) 410. The system can be in communication with multiple automated vehicles via any suitable communication network via a network interface implemented, for example, by the communications subsystem 430. The instructions executable by the processor(s) 410 can include instructions to receive a traffic event trigger responsive to detection, by a sensor of a detecting automated vehicle of multiple automated vehicles, of a traffic event proximate to the detecting automated vehicle, the multiple automated vehicles being in communication with each other via the communication network; to determine, responsive to the traffic event trigger, an impacted vehicle set as those of the automated vehicles to be impacted by the traffic event; to compute, responsive to the traffic event trigger, multiple alternative routing options available for physical routing of the impacted vehicle set; and to compute a multi-path rerouting of the impacted vehicle set by assigning each of the automated vehicles of the impacted vehicle set to one of multiple subsets, and assigning each of the multiple subsets to a respective one of the multiple alternative routing options, such that the multi-path rerouting of the impacted vehicle set mitigates an aggregated impact of the traffic event on the impacted vehicle set. In some embodiments, the instructions executable by the processor(s) 410 include instructions to direct each of the automated vehicles of the impacted vehicle set, via the communication network, to travel in accordance with the respective one of the plurality of alternative routing options assigned to its subset.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 400, various computer-readable media can be involved in providing instructions/code to processor(s) 410 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 425. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer can load the instructions into its dynamic memory and send the instructions as signals over a transmission medium to be received and/or executed by the computer system 400.

The communications subsystem 430 (and/or components thereof) generally will receive signals, and the bus 405 then can carry the signals (and/or the data, instructions, etc., carried by the signals) to the working memory 435, from which the processor(s) 410 retrieves and executes the instructions. The instructions received by the working memory 435 may optionally be stored on a non-transitory storage device 425 either before or after execution by the processor(s) 410.

It should further be understood that the components of computer system 400 can be distributed across a network. For example, some processing may be performed in one location using a first processor while other processing may be performed by another processor remote from the first processor. Other components of computer system 400 may be similarly distributed. As such, computer system 400 may be interpreted as a distributed computing system that performs processing in multiple locations. In some instances, computer system 400 may be interpreted as a single computing device, such as a distinct laptop, desktop computer, or the like, depending on the context.

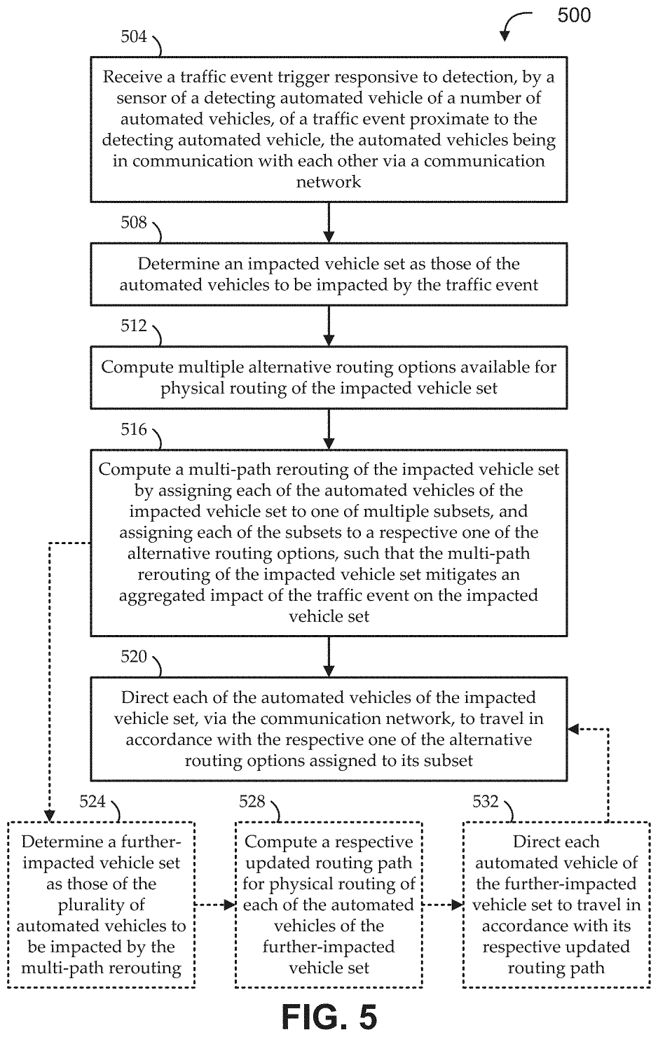

Systems including those described above can be used to implement various methods 500. FIG. 5 shows a flow diagram of an illustrative method 500 for multi-path routing of networked automated vehicles, according to various embodiments. Embodiments of the method 500 begin at stage 504 by receiving a traffic event trigger responsive to detection, by a sensor of a detecting automated vehicle, of a traffic event proximate to the detecting automated vehicle. The detecting automated vehicle is one of multiple automated vehicles that are in communication with each other via a communication network. In some implementations, the communication network is, or includes, an ad hoc network having multiple member nodes that dynamically change in accordance with which of the automated vehicles is in proximity to at least one other of the automated vehicles that presently corresponds to a member node of the ad hoc network. In certain such implementations, at any given time, a particular one of the automated vehicles is in communication with others of the automated vehicles via an ad hoc network based on parameters of the other automated vehicles, such as each other automated vehicle's location (e.g., whether the other automated vehicle is in proximity to the particular one of the automated vehicles), its link quality (e.g., whether a sufficient link can be maintained between the particular one of the automated vehicles and the other automated vehicle, due to interference, etc.), its affiliation (e.g., certain automated vehicles may only have communication compatibility or authorization with other vehicles of a same make, same vehicle class, etc.), etc. In some embodiments, multiple trigger signals are received, each responsive to detection by one or more sensors of a respective one of multiple detecting automated vehicles of the plurality of automated vehicles. In such embodiments, the traffic event trigger received in stage 504 can be generated in response to determining that the multiple trigger signals collectively indicate the traffic event.

At stage 508, embodiments can determine (e.g., responsive to the traffic event trigger) an impacted vehicle set as those of the plurality of automated vehicles to be impacted by the traffic event. In some embodiments, the determining at stage 508 includes determining a geographic region within which any automated vehicles are to be impacted by the traffic event in relation to the impending impact on the detecting automated vehicle, and determining the impacted vehicle set to include those of the automated vehicles determined to be within the geographic region. In implementations using an ad hoc network, the impacted vehicle set is determined at least according to which of the automated vehicles are presently in communication via the ad hoc network. In some implementations, the traffic event (associated with the traffic event trigger received at stage 504) is detected to have an impending impact on the detecting automated vehicle, and the impacted vehicle set is determined in stage 508 as those of the automated vehicles to be impacted by the traffic event in relation to the impending impact on the detecting automated vehicle. In such implementations, the impacted vehicle can include the detecting automated vehicle and multiple ones of the automated vehicles other than the detecting automated vehicle. For implementations in which the traffic event trigger received in stage 504 is generated in response to determining that multiple trigger signals from multiple detecting automated vehicles collectively indicate the traffic event 144, the impacted vehicle set can be determined at stage 508 to include the multiple detecting automated vehicles.

At stage 512, embodiments can compute (e.g., responsive to the traffic event trigger) multiple alternative routing options available for physical routing of the impacted vehicle set. In some embodiments, the traffic event trigger received in stage 504 indicates that the traffic event impacts a vehicle traffic flow on a first of multiple roadways, and at least one of the alternative routing options corresponds to physically rerouting one or more of the impacted vehicle set via a second of the roadways to physically avoid the traffic event. In other embodiments, the traffic event trigger received in stage 504 indicates that the traffic event impacts a vehicle traffic flow on a subset of lanes of a roadway having multiple lanes, and at least one of the plurality of alternative routing options corresponds to physically rerouting one or more of the impacted vehicle set via at least another of the lanes (other than the impacted subset). In some embodiments, at least one of the alternative routing options corresponds to changing a travel speed of one or more of the impacted vehicle set.

At stage 516, embodiments can compute a multi-path rerouting of the impacted vehicle set by assigning each of the automated vehicles of the impacted vehicle set to one of multiple subsets, and assigning each subset to a respective one of the alternative routing options. The multi-path rerouting can be computed so as to mitigate an aggregated impact of the traffic event on the impacted vehicle set. At stage 520, embodiments can direct each of the automated vehicles of the impacted vehicle set, via the communication network, to travel in accordance with the respective alternative routing option assigned to its subset.

Some embodiments of the method 500 continue by further determining, in stage 524, subsequent to computing the multi-path rerouting of the impacted vehicle set in stage 516 (and/or subsequent to the directing in stage 520), a further-impacted vehicle set as those of the automated vehicles to be impacted by the multi-path rerouting of the impacted vehicle set. The further-impacted vehicle set can be disjoint from the impacted vehicle set. At stage 528, such embodiments can compute (e.g., responsive to the second determining) a respective updated routing path for physical routing of each of the automated vehicles of the further-impacted vehicle set. At stage 532, such embodiments can direct each of the automated vehicles of the further-impacted vehicle set to travel in accordance with its respective updated routing path.

As described herein, steps of the method 500 can be performed by any suitable component at any suitable node of a network environment. In some implementations, all of stages 504-520 (e.g., and, in some cases, stages 524-532) are performed by the detecting automated vehicle. In other implementations, all of stages 504-520 (e.g., and, in some cases, stages 524-532) are performed by a back-end computational network. For example, the receiving at stage 504 includes receiving a trigger signal indicating the traffic event trigger, by the back-end computational system from the detecting automated vehicle via the communication network; and the directing at stage 520 includes communicating instructions by the back-end computational system to each of the automated vehicles of the impacted vehicle set via the communication network, such that each of the automated vehicles of the impacted vehicle set travels in accordance with the respective one of the plurality of alternative routing options assigned to its subset in response to receiving the instructions.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for multi-path routing of networked automated vehicles, the method comprising:
receiving a traffic event trigger responsive to detection, by a sensor of a detecting automated vehicle of a plurality of automated vehicles, of a traffic event proximate to the detecting automated vehicle, the plurality of automated vehicles being in communication with each other via a communication network;
determining, responsive to the traffic event trigger, an impacted vehicle set as those of the plurality of automated vehicles to be impacted by the traffic event;
computing, responsive to the traffic event trigger, a plurality of alternative routing options available for physical routing of the impacted vehicle set;
computing a multi-path rerouting of the impacted vehicle set by assigning each of the automated vehicles of the impacted vehicle set to one of a plurality of subsets, and assigning each of the plurality of subsets to a respective one of the plurality of alternative routing options, such that the multi-path rerouting of the impacted vehicle set mitigates an aggregated impact of the traffic event on the impacted vehicle set; and
directing each of the automated vehicles of the impacted vehicle set, via the communication network, to travel in accordance with the respective one of the plurality of alternative routing options assigned to its subset.

2. The method of claim 1, wherein:
the communication network comprises an ad hoc network having a plurality of member nodes that dynamically changes in accordance with which of the plurality of automated vehicles is in proximity to at least one other of the plurality of automated vehicles that presently corresponds to a member node of the ad hoc network; and
the automated vehicles of the impacted vehicle set are in communication via the ad hoc network.

3. The method of claim 1, wherein:
the traffic event is detected by the sensor to have an impending impact on the detecting automated vehicle;
the impacted vehicle set is determined as those of the plurality of automated vehicles to be impacted by the traffic event in relation to the impending impact on the detecting automated vehicle; and
the impacted vehicle set comprises the detecting automated vehicle and multiple ones of the plurality of automated vehicles other than the detecting automated vehicle.

4. The method of claim 1, wherein:
the steps of receiving, determining, computing the plurality of alternative routing options, computing the multi-path rerouting of the impacted vehicle set, and directing are each performed by the detecting automated vehicle.

5. The method of claim 1, wherein:
the receiving comprises receiving a trigger signal indicating the traffic event trigger, by a back-end computational system from the detecting automated vehicle via the communication network;
the steps of determining, computing the plurality of alternative routing options, and computing the multi-path rerouting of the impacted vehicle set; and
the directing comprises communicating instructions by the back-end computational system to each of the automated vehicles of the impacted vehicle set, such that each of the automated vehicles of the impacted vehicle set travels in accordance with the respective one of the plurality of alternative routing options assigned to its subset in response to receiving the instructions.

6. The method of claim 1, wherein the receiving comprises:
receiving a plurality of trigger signals, each responsive to detection, by respective one or more sensors of a respective one of multiple detecting automated vehicles of the plurality of automated vehicles; and
generating the traffic event trigger in response to determining that the plurality of trigger signals collectively indicate the traffic event.

7. The method of claim 6, wherein the impacted vehicle set is determined to comprise the multiple detecting automated vehicles.

8. The method of claim 1, wherein the determining comprises:
determining a geographic region within which any automated vehicle of the plurality of automated vehicles is to be impacted by the traffic event; and
determining the impacted vehicle set to comprise those of the plurality of automated vehicles determined to be within the geographic region.

9. The method of claim 1, further comprising:
second determining, subsequent to computing the multi-path rerouting of the impacted vehicle set, a further-impacted vehicle set as those of the plurality of automated vehicles to be impacted by the multi-path rerouting of the impacted vehicle set, the further-impacted vehicle set being disjoint from the impacted vehicle set;
computing, responsive to the second determining, a respective updated routing path for physical routing of each of the automated vehicles of the further-impacted vehicle set; and
directing each of the automated vehicles of the further-impacted vehicle set to travel in accordance with its respective updated routing path.

10. The method of claim 1, wherein:
the traffic event trigger indicates that the traffic event impacts a vehicle traffic flow on a first of a plurality of roadways; and
at least one of the plurality of alternative routing options corresponds to physically rerouting one or more of the impacted vehicle set via a second of the plurality of roadways to physically avoid the traffic event.

11. The method of claim 1, wherein:
the traffic event trigger indicates that the traffic event impacts a vehicle traffic flow on a subset of lanes of a roadway having a plurality of lanes; and
at least one of the plurality of alternative routing options corresponds to physically rerouting one or more of the impacted vehicle set via at least one of the plurality of lanes other than the subset of lanes.

12. The method of claim 1, wherein:
at least one of the plurality of alternative routing options corresponds to changing a travel speed of one or more of the impacted vehicle set.

13. A multi-path routing system for networked automated vehicles, the system comprising:
an event detector to generate a traffic event trigger responsive to detection, by a sensor of a detecting automated vehicle of a plurality of automated vehicles, of a traffic event proximate to the detecting automated vehicle, the plurality of automated vehicles being in communication with each other via a communication network;
a vehicle tracker in communication with the event detector to determine, responsive to the traffic event trigger, an impacted vehicle set as those of the plurality of automated vehicles to be impacted by the traffic event;
a multi-path routing processor, in communication with the event detector and the vehicle tracker, to:
compute a plurality of alternative routing options available for physical routing of the impacted vehicle set responsive to the traffic event trigger and in accordance with stored mapping data; and
compute a multi-path rerouting of the impacted vehicle set by assigning each of the automated vehicles of the impacted vehicle set to one of a plurality of subsets, and assigning each of the plurality of subsets to a respective one of the plurality of alternative routing options, such that the multi-path rerouting of the impacted vehicle set mitigates an aggregated impact of the traffic event on the impacted vehicle set; and
an automated vehicle controller, in communication with the multi-path routing processor and the communication network, to direct each of the automated vehicles of the impacted vehicle set, via the communication network, to travel in accordance with the respective one of the plurality of alternative routing options assigned to its subset.

14. The multi-path routing system of claim 13, wherein:
the detecting automated vehicle comprises an on-board computational system having the event detector, the vehicle tracker, the multi-path routing processor, and the automated vehicle controller.

15. The multi-path routing system of claim 13, wherein:
the detecting automated vehicle is in communication, via the communication network, with a back-end computational system having the vehicle tracker, the multi-path routing processor, and the automated vehicle controller.

16. The multi-path routing system of claim 13, wherein:
the communication network comprises an ad hoc network having a plurality of member nodes that dynamically changes in accordance with which of the plurality of automated vehicles is in proximity to at least one other of the plurality of automated vehicles that presently corresponds to a member node of the ad hoc network; and
the automated vehicles of the impacted vehicle set are in communication via the ad hoc network.

17. The multi-path routing system of claim 13, wherein:
the event detector generates the traffic event trigger responsive to receiving a plurality of trigger signals, each responsive to detection, by one or more sensors of a respective one of multiple detecting automated vehicles of the plurality of automated vehicles, and responsive to determining that the plurality of trigger signals collectively indicate the traffic event.

18. The multi-path routing system of claim 13, wherein:
the traffic event trigger indicates that the traffic event impacts a vehicle traffic flow on a first of a plurality of roadways; and
at least one of the plurality of alternative routing options corresponds to physically rerouting one or more of the impacted vehicle set via a second of the plurality of roadways to physically avoid the traffic event.

19. A system for multi-path routing of networked automated vehicles, the system comprising:
a network interface coupled with a communication network,
one or more processors; and
non-transient memory having, stored thereon, instructions, which, when executed, cause the one or more processors to perform steps comprising:
receiving a traffic event trigger responsive to detection, by a sensor of a detecting automated vehicle of a plurality of automated vehicles, of a traffic event proximate to the detecting automated vehicle, the plurality of automated vehicles being in communication with each other via a communication network;
determining, responsive to the traffic event trigger, an impacted vehicle set as those of the plurality of automated vehicles to be impacted by the traffic event;
computing, responsive to the traffic event trigger, a plurality of alternative routing options available for physical routing of the impacted vehicle set; and
computing a multi-path rerouting of the impacted vehicle set by assigning each of the automated vehicles of the impacted vehicle set to one of a plurality of subsets, and assigning each of the plurality of subsets to a respective one of the plurality of alternative routing options, such that the multi-path rerouting of the impacted vehicle set mitigates an aggregated impact of the traffic event on the impacted vehicle set.

20. The system of claim 19, wherein the instructions, when executed, cause the one or more processors to perform steps further comprising:
directing each of the automated vehicles of the impacted vehicle set, via the communication network, to travel in accordance with the respective one of the plurality of alternative routing options assigned to its subset.
